(19) United States
(12) Patent Application Publication
(10) Pub. No.: US 2008/0281649 A1
(43) Pub. Date: Nov. 13, 2008

(54) System and method for automated release tracking

(76) Inventor: Daniel R. Morris, Virginia Beach, VA (US)

Correspondence Address: Thomas F. Bergert;Williams Mullen, Suite 700, 8270 Greensboro Drive, McLean, VA, 22102, US

(21) Appl. No.: 10/630,532

(22) Filed: Jul. 30, 2003

Related U.S. Application Data
(60) Provisional application No. 60/399,372, filed on Jul. 30, 2002.

(51) Int. Cl. G06Q 40/00; G06Q 10/00; G06F 17/30

(52) U.S. Cl. 705/7; 705/30

(57) ABSTRACT

A real estate transaction and release tracking system ensures deeds of trust, liens and other encumbrances are released in a timely manner after a specified (or statutory) period of time following settlement of a real estate transaction. Based on information provided by an agent, such as an escrow agent or a settlement agent, the system creates a unique electronic record for each real estate transaction entered by the agent. The system tracks lien status information, either automatically from other computers or via manual input from searchers, and uses this status information to track each real estate transaction. The system monitors the records and indicates when a lien holder has failed to release their lien after a statutory time period that begins after the passing of the settlement date. When the statutory time period has passed, the system can generate a number of forms, including a demand letter as controlled optionally by the system or the user. The demand letter can be sent to the lien holder demanding them to release the lien. If the lien is not thereafter released, further legal documents can be generated and sent to a law firm or enforcement agent for legal action to be taken against the delinquent lien holder.

### CROSS-REFERENCE TO RELATED APPLICATIONS

This application claims the benefit of U.S. application Ser. No. 60/399,372, filed Jul. 30, 2002, entitled “Title Tracking System”, and U.S. application Ser. No. 10/308,268, filed Dec. 4, 2002, entitled “Internet Based Release Tracking System”.

### FIELD OF THE INVENTION

The present invention relates generally to the fields of real estate finance and information transfer, and more specifically to a system for the association and verification of public record indexing information related to a real estate lien instrument (e.g. Deeds of Trust or Mortgages) and the underlying payment obligations (e.g. Notes), the management of orders for and delivery of payoff information related to such payment obligations, and the timely release or re-conveyance of recorded lien instruments after the underlying obligation is fully or partially paid or satisfied following settlement.

### BACKGROUND OF THE INVENTION

Lenders, for purposes of this application, shall be synonymous with Lien creditors, assignees, or payees of Notes entitled to principal, interest payments and/or penalties and fees associated with such Notes. Notes and other contracts providing evidence of debt are generally used to describe the underlying obligations secured by the lien. Liens in this application shall include, without limitation, Deeds of Trust, Mortgages, Deeds to Secure Debt, or any instrument recorded in the public repositories for the purpose of notifying the public of Lender's security interests associated with the repayment of a Promissory Note or other obligation on real property. Settlement Date for purposes of this application shall apply to the date of disbursement, date of notice of payoff payment to the Payoff Lender or the date of settlement. Such date or notice varies depending on jurisdiction, business custom or statute. Title Insurance Companies shall include companies and their agencies writing title insurance contracts managing the risk associated with ownership of property interests in real property. Transaction Data shall include, inter alia, title, recording, indexing, financial and informational data related to the identification, qualification and quantification of relevant information associated with real estate liens and their underlying Notes and obligations.

There are two common types of real estate transactions utilizing lender financing—the sale and the refinance. Both forms involve commitment from a lender to provide funds to borrowers necessary for the purchase or refinance of the property. Both require establishment of certain rights (depending on jurisdiction) in the property for the benefit of the lender to secure the repayment of the loan. In a sale, the “Buyer” applies to a lender for funds to pay to the seller for the transfer of the title of real property. In a refinance an owner or “Borrower” applies to a lender for funds to replace or “payoff” a prior loan secured by real property. Assuming the loan is approved, in both transaction types, the Lender, through the assistance of the Settlement Agent, establishes a security interest or equitable right in the real property concurrently with the borrower/owner that allows the lender to take possession and sell the property in the event of default and apply the proceeds to the balance of the defaulted Note.

To establish the security interest, the Lender requires the Borrower/Buyer to execute legal documents establishing this equitable interest or lien on the property. This lien document is then indexed and published in the public land record system of the particular city or county wherein the property is situated. The publication provides notice to the public that the Lender holds a lien or security interest in the property. In the majority of jurisdictions, priority of the lien is of utmost importance. Priority is established by the date of recording. A lien recorded prior in time to a second lien will have priority—that is the beneficiary of the lien with priority (the payoff lender for this discussion) will have the right to exercise certain rights inherent in the lien to the detriment of any lien holder later in time (the originating lender). The priority status is sometimes referred to in the industry as “first in time first in right”. Hence, during the closing of the real estate transaction, measures are taken to establish the priority of the security interest of a lender providing funds to the transaction, over that of prior lien holders.

In a typical real estate transaction the Settlement Agent or Escrow Agent orders an evaluation of the public record to establish the existing liens on the real property subject to the upcoming transaction. Such evaluation is in most cases based on an examination of the indexed records in the courthouse having jurisdiction of the physical location of the property. Title researchers or abstractors examine the records and report the legal title status to the Settlement Agent. This “Title Report” includes, among other data, the current owner, and current liens and encumbrances or claims of record on the property.

There are many varieties of liens that may attach to title of real property. Although the embodiment of the subject invention applies to many types of liens, the primary lien for discussion purposes involves liens established by the owners of real property conveying a security interest to lenders in return for lender's payment of money to the buyer/owner for either the purchase of the property or the refinance of the real property. These liens are commonly called Deeds of Trust, Deeds to Secure Debt and/or Mortgages.

The borrower, title insurance underwriter, and/or Originating Lender provide contracts and instructions to the Settlement Agent to payoff existing notes and satisfy or remove their liens in order to establish the proper priority of a new lien on the property. Usually a title company underwriter reviews the title report and enumerates certain requirements in a Title Binder to bind title insurance coverage for the benefit of the Originating Lender. This title coverage protects the security interest of the Originating Lender established by the new lien instrument. It is therefore important for both the lender and title insurance company that the prior liens be properly released or re-conveyed following closing of the new loan.

In a typical closing the Settlement Agent collects funds from the Originating Lender and various parties and disburses them pursuant to the terms of the settlement documents. One particular disbursement—the Payoff—is critical to the establishment of the Originating Lender's priority security interest in the real property. The term “payoff” refers to the funds designated to satisfy the note or notes underlying existing lien(s) on the real property.

This payment tendered by the Settlement Agent satisfies the Obligor's obligations dictated by the Note, however, in most cases the Settlement Agent does not have the authority to release the lien on behalf of the Payoff Lender. The Payoff Lender holding the note has a legal obligation to “release” or “re-convey” the lien within a statutory time period. As a part of their duties under the escrow terms, the Settlement Agent must then keep its file open for some time after the closing to search the Court records to determine whether the Payoff Lender complied with their legal duty to release or re-convey the lien on the real property.

In most States the Settlement Agent cannot release or re-convey the lien despite their assurance that the Payoff Lender accepted the payoff disbursement funds.

On average, up to thirty percent of real property liens with fully satisfied underlying notes are not released within the statutory period. When this delay occurs, it causes many undue problems and risks for the Originating Lender, the Settlement Agent, the title insurance company, the seller, the borrower (in a refinance), and the buyer (in a sale). Most States have enacted laws to motivate the Payoff Lenders to comply with their duty to release the lien or re-convey their interest after the note they hold or service has been paid and satisfied. Typically, there is a first statute that sets a time period within which sellers must release or re-convey after payment of the underlying obligation. A second statute then imposes a fine, penalty or forfeiture on Payoff Lenders that fail to release or re-convey within the statutory time period.

While some governmental storage repositories, such as county courthouses, still store records in traditional forms, e.g. in paper documents, micro fiche or bound volumes, many more governmental storage repositories are now storing land conveyance records and indexes in electronic form. An “electronic index” stores all of the descriptive information regarding a specific real estate transaction that a traditional paper record stored on one or more pieces of papers. Typically an electronic index will have one or more fields wherein each field stores a different piece of information, such as settlement date, seller's name, stored image of the original document etc., pertinent to the real estate transaction. Each field in an electronic index is typically assigned an attribute, which describes to the type of information stored in the field. The term attributes is also commonly used to describe the features or details that are stored in an electronic index. All electronic storage sites and storage repositories have at least one system administrator that monitors the system and aids in performance of the system's overall purpose. Because of the increased number of real estate secured transactions most courthouses or governmental repositories of indexing and filing real estate documents, are inundated with increasing numbers of documents to index and record. Typically lien releases and re-conveyances are recorded last as they are not time-critical—that is, the order of recording does not affect the efficacy or import of the release instrument.

Settlement Agents typically use electronic systems or computer programs to collect and manage information relevant to the settlement process (“Settlement Programs”). There is a trend in the real estate transaction settlement industry to utilize such Settlement Programs to carry out the various duties of the Settlement Agent in its role as escrow agent in a real estate transaction closing.

A release tracking system that could tap into such Settlement Programs, Payoff Lender's data bases and the many electronic storage repositories across a State, or the Country, could benefit the Payoff Lenders seeking statutory compliance, Originating Lenders providing loans secured by real property, the title insurance companies writing title insurance policies on real property and owners/buyers of real property by monitoring the actions of Payoff Lenders under a legal duty to release or re-convey liens, notifying Settlement Agents of the status of the release or re-conveyance, alerting Payoff Lenders that they are out of compliance, invoking remedial measures established in particular States and by enforcing the laws enacted to protect those holders of interest in real property. Such a system can (1) dramatically decrease the amount of time and money Settlement Agents expend to verify and enforce the release or re-conveyance requirements, (2) decrease the risk incurred by Title Insurance Companies insuring priority of Originating Lender's security interests on real property, (3) reduce the cost of release and re-conveyance that Payoff Lenders incur to navigate the dynamic requirements of each State to effectuate the release or re-conveyance and (4) ensure owners that satisfied liens will not encumber the title of their real property.

The utility and popularity of the Internet arises from the fact that hundreds of thousands of separate computer operators and computer networks independently use common data transfer protocols to exchange information. There is no centralized storage location or communication channel for the Internet. The explosive growth in popularity of the Internet is in large part based on the unrestricted communication medium it provides. The Internet has created a very low cost forum in which people can easily publish information and gain access to other desired information. Many computers access the Internet through a device called modem. A modem, which stands for modulator-demodulator, is a device that connects a computer to a telephone line or cable and allows information to be transmitted to or received from another computer or server. Information that is sent over a telephone line is converted by the modem into an audio signal, which is then transmitted by telephone lines to the receiving modem, which converts the signal into information that the receiving computer can understand. Of course connections to the Internet, that do not include telephone lines, are also frequently used. Computers with an all digital connection to the Internet typically use a device called a network card to transmit and receive information. Handshaking is the term used for signal acknowledging, between two computers, that communication or the transfer of information can take place. Handshaking may either be controlled by hardware or software.

The Internet is based on the concept of a client-server relationship between computers, also called a client/server architecture. To access information on the Internet, a user must first log on, or connect, to the client computer's host network. This connection can be established with or without user intervention depending on the software. Once a connection has been established, the user may request information from a remote server. If the information requested by the user resides on one of the computers on the host network, that information is quickly retrieved and sent to the user's terminal. If the information requested by the user is on a server that does not belong to the host LAN, then the host network connects to other networks until it makes a connection with the network containing the requested server. In the process of connecting to other networks, the host may need to access a router, a device that determines the best connection path between networks and helps networks to make connections. Once the client computer makes a connection with the server containing the requested information, the server sends the information to the client in the form of a file. A special computer program called a browser enables the user to view the file. Examples of Internet browsers are Mosaic, Netscape, and Internet Explorer. Non-multimedia documents do not need browsers to view their text-only contents and many multimedia documents provide access to text-only versions of their files. The process of retrieving files from a remote server to the user's terminal is called downloading. The process of transferring files to a remote server is called uploading.

### SUMMARY OF THE INVENTION

The present invention provides a system for collecting, from various sources, information related to a real estate secured financial transaction, associating lien indexing and other lien identifying data with Promissory Note and Servicing data, ordering and delivery of payoff information provided by Payoff Lenders, tracking the financial transaction, and ensuring that each lien securing the real estate, including deeds of trust, mortgages and deeds to secure debt, is released in a timely fashion after an obligation underlying a lien has been satisfied. The system comprises at least one server having several components, wherein the server stores and executes multiple programs, including a subscriber management program that prompts a user that is involved in the real estate secured financial transaction for required and optional transaction data and financial data, and creates a subscriber profile for the agent. A record management program obtains from a user involved in the real estate financial transaction or from other sources, information related to the transaction and populates and manages a transaction record based on the transactional data. An order and invoice program associates and verifies lien information provided by agent with Payoff Lender's Note and Servicing information, compares and verifies such information, and orders a payoff statement from a Payoff Lender. The order and invoice program also provides a communication link associated with the transaction record between the Settlement Agent and Payoff Lender. In the event data (such as the lien indexing and identification data) is invalid, the system can provide notification and curative procedures.

The order and invoice program creates an invoice for the agent, verifies the transaction data, and upon verification, creates a transaction record based on the transaction data, and authorizes a release of real estate forms to authorized parties to the transaction. A real estate forms program generates one or more forms customized to the agent and the real estate secured financial transaction, and transmits printable embodiments of the forms to the authorized party.

A research/account management program assigns transaction records that must be tracked by manual researching to a researcher/account manager, provides an interface for the researcher/account manager to input search results, initiates a review of research results, and authorizes payment to researchers/account managers. The research/account management program also provides an interface for receiving update information from other computers pertaining to transaction records that can be tracked electronically.

A tracking program receives the research results and update information from the research/account management program and tests specified fields of transaction records to see if lien holders, having the obligation underlying their lien satisfied, have failed to release their lien on the real estate within the time period allowed by law. If the tracking program finds that a lien holder has failed to timely release their lien, the program sends out one or more notifications to another program, a system administrator or to a law office.

A transaction record can include more than one lien and in such situations the tracking program creates a lien sub-record for each lien and tracks a status of each lien. Each lien record contains at least one field identifying the county or city where a lien record is indexed and a unique identifying number or combination of numbers (e.g. book and page, volume and page or liber and folio) such that the identification of a recorded lien shall always be unique.

A legal forms program is also provided and, upon receipt of a notification from the tracking program, or a system administrator, the legal forms program generates one or more customized legal forms pertaining to the real estate secured financial transaction and transmits printable embodiments of the legal forms to a law office or another system administrator. The one or more real estate forms that are provided to the agent can include payoff letters, invoices, demand letters, certificates of satisfaction, release instruments, fax cover sheets, shipping labels, and transaction reports, wherein the transaction reports can include lien information, obligor information, settlement information, pay-off information and loan information.

The legal forms program includes legal form templates for multiple jurisdictions that are used to generate the one or more customized legal forms. The legal forms include release instruments, demand letters, cover letters, certificate of satisfactions, complaints and summons. The forms generated by the system may contain a barcode such as a two-dimensional barcode of the PDF417 type or similar symbologies containing certain subsets of the transaction data. The system is preferably accessed by researchers and other computers via the Internet, and the real estate forms and legal forms are transmitted over the Internet. Each transaction record includes multiple fields and multiple attributes, and a Settlement Date is assigned to at least one field in each record.

The research management program and forms program includes multiple protocols and data mining programs that are used to interact with, and receive the update information from, the other computers. The research management program receives manual search results at random times from the researchers. The subscriber profile that is created by the subscriber management program is used by the real estate forms program and the legal forms program when generating forms. The system may also comprise at least two servers that are used to store and execute the programs, wherein the subscriber management program and the order and invoice program are stored and executed on a first server and the tracking program and the transaction records are stored on a second server.

The programs described above work together as part of a system having components for tracking liens, storing lien records, managing liens, determining a lien status, reporting lien and note information, and communicating lien-related information.

It is an object of the present invention to provide a system for easy maintenance of payoff ordering and release tracking at any desired time interval.

It is a further object to provide a core release tracking database and a series of supplementary release tracking databases that contain report masks customized for the local legal systems.

It is another object to provide complete analysis for the liens based on settlement date and other temporal metrics.

It is still a further object to provide the ability to create an unlimited number of attribute lists to describe an item within the database.

It is still another object to provide data consumers with customized views of the release tracking data.

It is still another object to provide receptacle programs into which data relevant to the transaction is pushed to the system.

It is still another object to provide the ability to pull data from local resident computer databases into the system.

### BRIEF DESCRIPTION OF THE DRAWINGS

The invention of the present application will now be described in more detail with reference to the accompanying drawings, given only by way of example, in which:

FIG. 1 is a block diagram illustrating one aspect of the system and method of the present invention.

FIG. 2 is an exemplary schematic diagram of one embodiment of the present invention.

FIG. 3 shows exemplary communication channels for sending information to the system of the present invention.

FIG. 4 shows exemplary communication channel for sending information from the system of the present invention.

FIG. 5 is a general flow chart showing steps involved in one embodiment of the present invention.

FIG. 6A is a flow chart showing exemplary steps of one embodiment of the present invention.

FIG. 6B is a flow chart showing further steps of one embodiment of the present invention.

FIGS. 7A & 7B are flow charts showing exemplary steps of the present tracking program of one embodiment of the present invention.

FIGS. 8 through 15 are sample user interfaces for use in connection with different embodiments of the present invention.

FIGS. 16 and 17 are schematic diagrams showing components associated with various embodiments of the present invention.

### DETAILED DESCRIPTION OF THE INVENTION

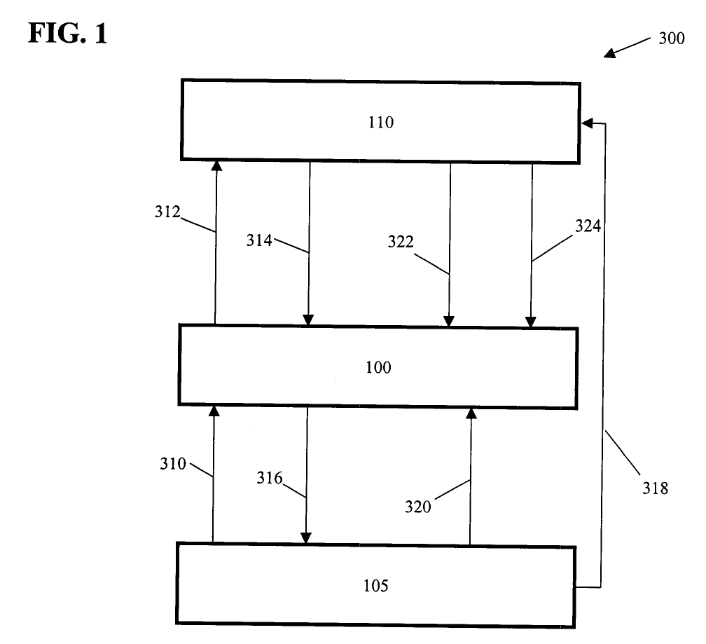

Referring to FIG. 1, the present release tracking system 300 comprises one or more servers 100 that receive, store, manage and track information relating to multiple real estate liens, title and financial transactions in multiple jurisdictions. Server 100 also stores jurisdiction and client-specific real estate transaction form masks, based on locally approved transaction forms, and can generate real estate transaction forms for a party involved in the transaction, such as an escrow or a settlement agent 105, Payoff Lender 110 or other user.

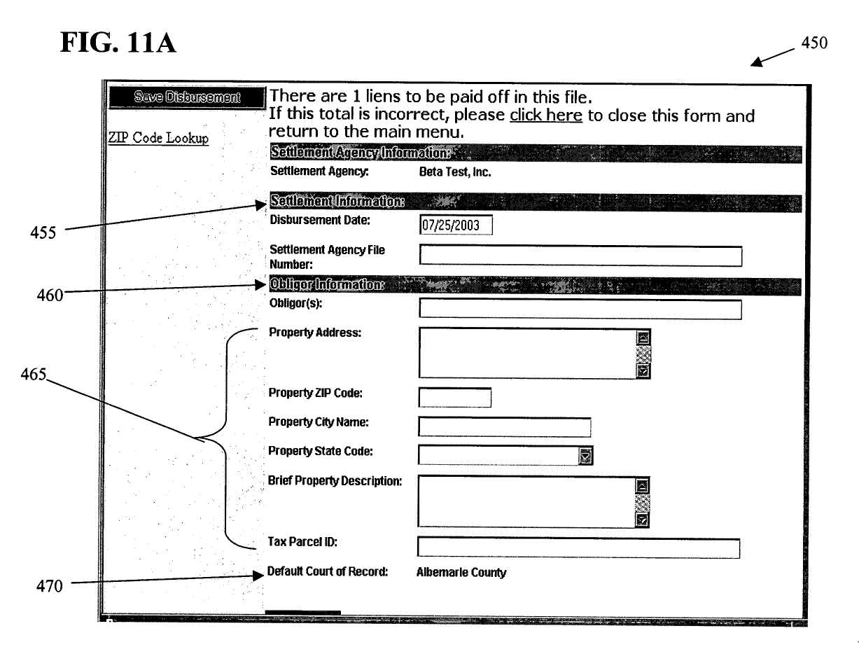

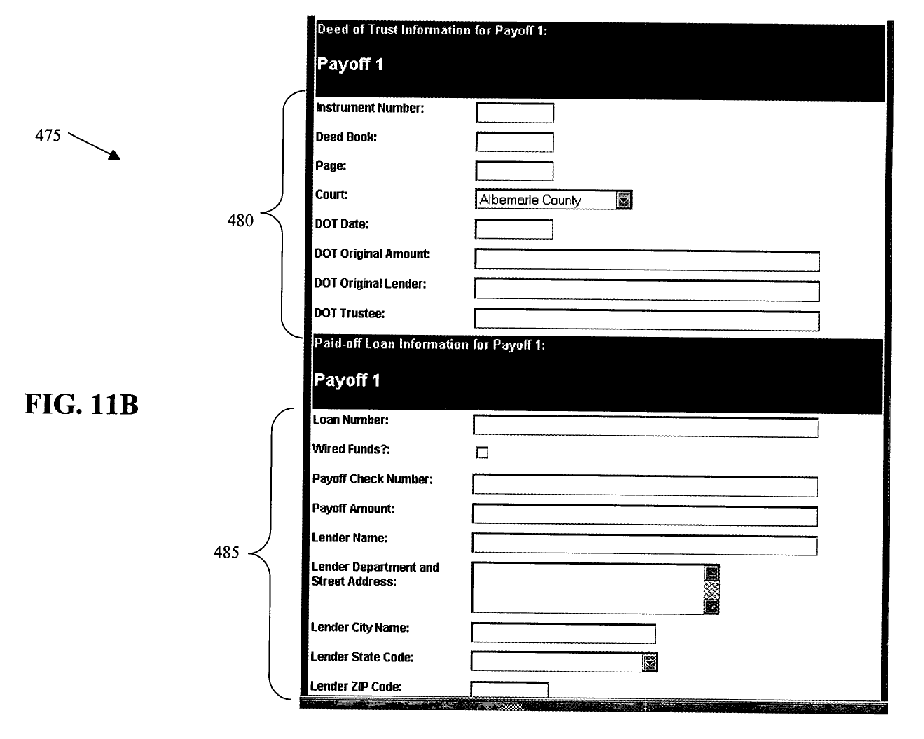

In the first exemplary exchange, as shown in FIG. 1, a note payoff and lien release as facilitated by the present invention is shown. In FIG. 1, the agent 105 provides informational, and financial data, to subscribe to an exemplary service in accordance with one aspect of the present invention, as at 310. The agent 105 provides Lien Identification, Note Identification and other transaction data relating to one or more transactions involving real estate, to server 100. As shown in FIG. 11B, lien identification information 480 can include an instrument number, deed book identification, page number, court identification, deed of trust (DOT) date, DOT original amount, DOT original lender and DOT trustee, for example. As further shown in FIG. 11B, note identification information 485 can include a loan number, an indication as to whether funds were wired, a payoff check number, payoff amount, lender name and address, and lender department, for example. In one embodiment, such information provided to the system may be automatically extracted from resident data in the agent 105's present local database system through special database record population programs designed for individual locally resident software programs or through manual input in various interfaces.

Interface programs associated with server 100 of the present system can verify and validate portions of the agent's input and can forward the transaction data to other portions of the present system, including, but not limited to, the order and invoice program and real estate forms program. In exchange 312, the Payoff Lender 110 receives an order for payoff containing both Note Identification and Lien Identification information. Such information may be validated by Payoff Lender 110 for authentication, accuracy and identification. In exchange 314, the Payoff Lender 110 delivers Payoff Information and/or queries dependent upon the Lender's validation protocol. In exchange 316, if information is validated, agent 105 will receive multiple customized documents containing such data necessary for utilization in a real estate closing transaction for the full or partial payment of the subject note and release or re-conveyance of the subject lien associated with said note. If such information is not validated, agent 105 will receive data via transfer 316 and/or documents sufficient to research the misinformation and communicate through the present system with the Payoff Lender 110 to cure the problem and clarify the payoff order. In one embodiment, such transactional information (payoff order, lien information etc.) resides in Server 100 until automatic or manual triggering events process, archive or otherwise manage the data. The present system can process the data throughout its active state using programs which can communicate and exchange this data with other vendor systems via electronic or other means to enhance, manage, append, or otherwise process the data to further add value.

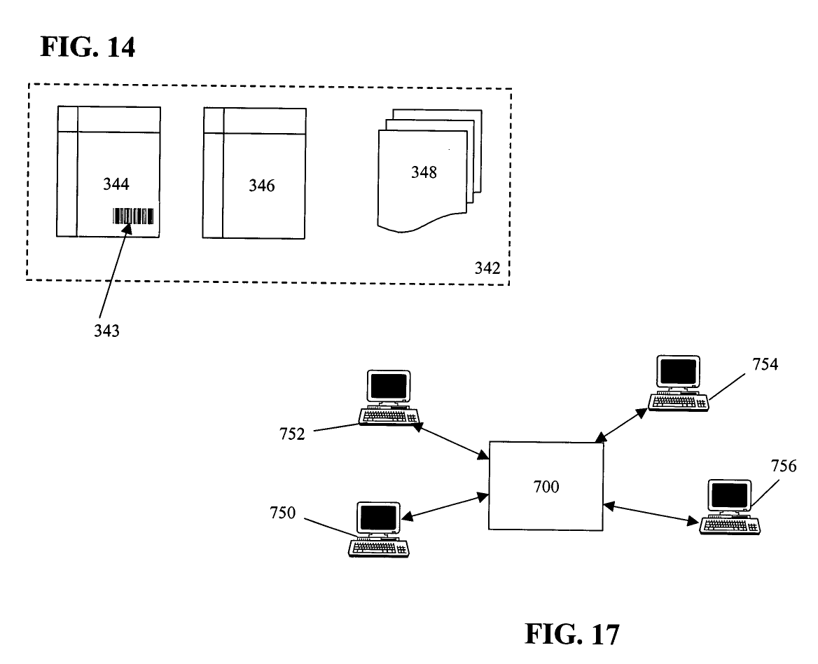

In exchange 318, following closing of the relevant real estate transaction, agent 105 transmits Payoff Funds with multiple documents that have been customized for the agent based on the transaction data that was entered into server 100, (the “Payoff Disbursement”) to the Payoff Lender. Such a payoff disbursement package is illustrated by way of example in FIG. 14, whereby the package 342 includes an invoice 344, a payoff transmittal letter 346, and forms 348 for the lender to complete and deliver, such as a notice of intent to release and/or a certificate of satisfaction, for example. In one embodiment, barcode symbologies 343 containing relevant data can be printed on one or more documents and can be readable/accessible though various reading barcode scanning devices connected to the system through network interfaces. Such transmission may occur through electronic transmission using server 100 as at 320 or through conventional vendor or governmental delivery methods such as at 318. In exchange 322, Payoff Lender can electronically or otherwise acknowledge receipt of the Payoff Disbursement to the server 100. In one embodiment, following such acknowledgement, Payoff Lender can utilize internal protocols to validate the sufficiency, amount, and validity of the payment. In exchange 324, if Payoff Disbursement does not meet the Payoff Lender's internal criteria, Payoff Lender transmits data identifying the Payoff Disbursement's invalid status to agent 105 through server 100, whereupon agent 105 may utilize additional customized documents to cure the defect. If Payoff Disbursement meets Payoff Lender's validation criteria, Payoff Lender's transmission can identify the Payoff Disbursement's valid status whereupon customized release documents can be generated as well as other relevant documents necessary for the authorization of release or re-conveyance of the real estate lien associated with the transaction. In one embodiment, document generation programs can be associated with server 100 or other local system of a settlement agent or payoff lender.

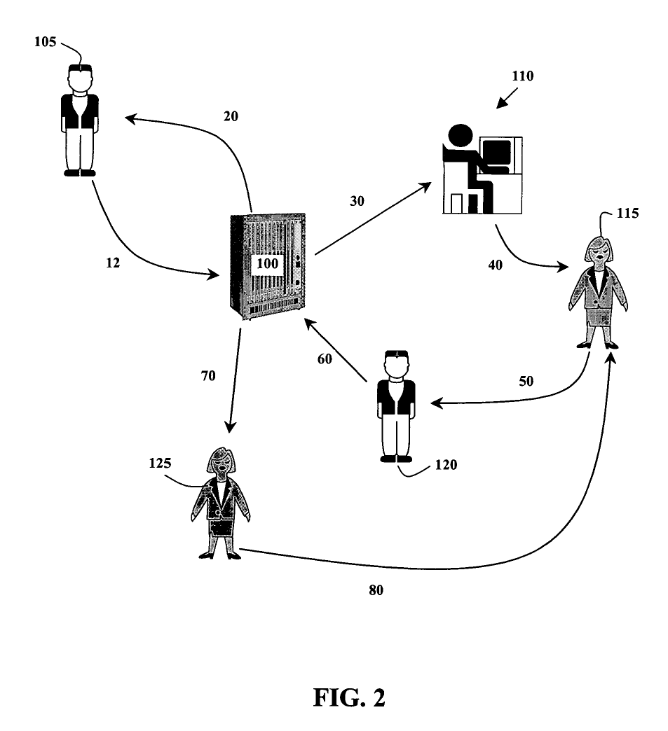

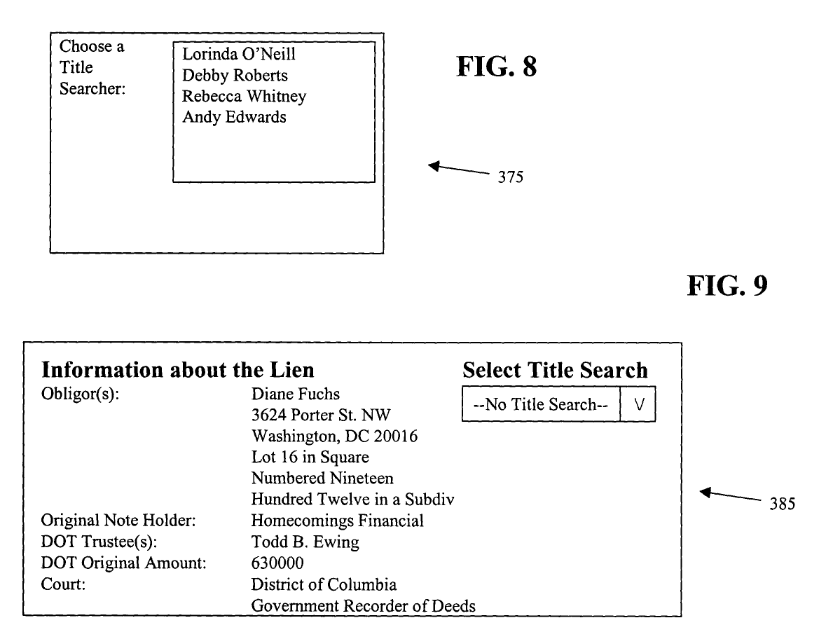

Throughout this process, programs resident in server 100 can examine all new records for completeness and, upon verification, determine whether or not the record can be tracked electronically. If electronic tracking of the real estate transaction that is the subject of the record is possible, the program can automatically initiate electronic tracking in one embodiment. If the record cannot be tracked electronically, in exchange 40, either the program or the administrator 110 can assign the record to a search manager 115, as shown in FIG. 2. In FIG. 2, agent 105 provides information and financial data as at 12, and can receive a confirmation and/or any necessary documents from server 100 as at 20. As at 30, server 100 can create a record for each transaction and notify a system administrator 110 of the new record's existence. In exchange 50, the search manager 115, or an automated program, can assign the record to a researcher 120. A sample searcher selection interface 375 is shown in FIG. 8. A sample record listing for searching is shown in the sample interface 385 of FIG. 9. After conducting manual searches through pertinent files, researcher 120 provides his search results to server 100 in exchange 60. In step 70, all search results are reviewed by quality assurance personnel 125 and/or quality assurance programs. Finally, in step 80, the quality assurance personnel send approvals or requests for corrections to the search manager 115 or automated program.

Real estate transaction forms typically require that the same information, such as property description, seller's name and address, sales price and settlement date, be entered in multiple forms. The agent 105 is motivated to use the present system because the system allows for ordering payoffs from Payoff Lenders, generation of important transmittal and legal documents and tracking lien release or re-conveyance through a single entry of the transaction information. Thereafter, software in server 100 enters each piece of transaction information in appropriate places in the real estate transaction and legal forms. The software then transmits the forms to be printed locally at the agent's location. Thus, the agent saves time by having the server 100 fill out the required transaction forms and guarantees that the same information is present on each form, i.e., avoids the possibility repetition errors. Release tracking begins when an agent 105 accesses server 100 and enters payoff ordering and lien information regarding a real estate transaction. Using the transaction information entered by the agent, server 100 creates a record for each payoff order and associated lien to be released in the real estate transaction. Server 100 transmits a payoff order to Payoff Lender subscribed to the system and awaits validation, verification and delivery of payoff statements and/or communications to the agent. The record remains in the system until data is appended, changed, or archived.

All transaction records include a disbursement date representing the date on which the settlement agent sent funds to the Payoff Lender. The disbursement date is tracked by the present system to ensure that paid off liens are released within the time period set by state law.

By the same token, the lender is motivated to use the present system because it can validate the information sent from the settlement agent with the Lender's system and generate a payoff letter to the Settlement Company. The present system can also provide a record which will remain in the system database awaiting several triggers, e.g. cancellation, receipt of payoff transmittal letter and check (or wire) from the settlement agent. Further, upon approval by the Payoff Lender of the payoff amount, the Payoff Lender can simply activate an authorization signal to the system to generate the release. The settlement agent, Payoff Lender or other authorized party can printout the release instrument or electronically send the release instrument to the appropriate courthouse.

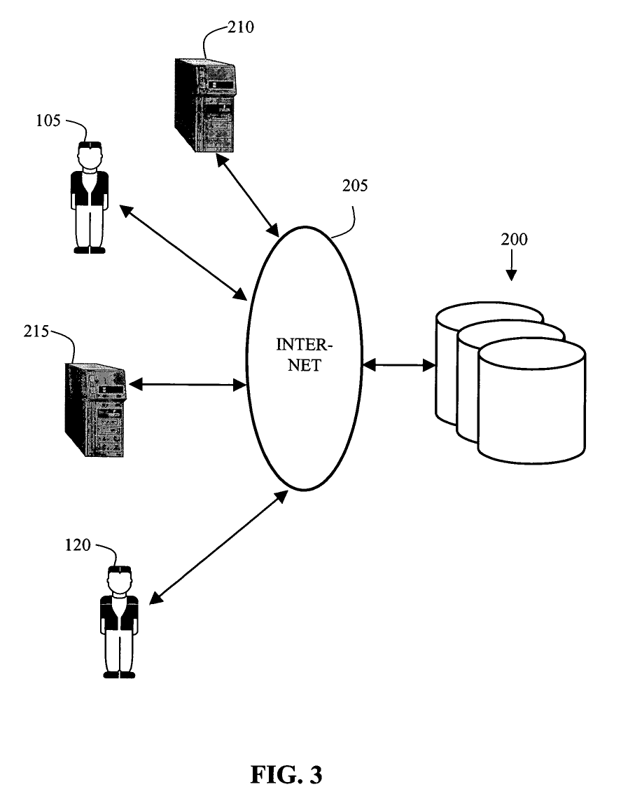

Referring to FIG. 3, the present system includes at least one server that stores and executes multiple programs 200. The programs 200 include multiple user interface programs, such as a subscriber management program and an order placement and invoicing program. The programs 200 of the present system also include a title search management program, a real estate forms program, a tracking program, and a legal forms program.

The present system can be designed to track any particular area of a real estate transaction. In an exemplary embodiment, the tracking program is used to ensure the timely release of deeds of trust by lenders after the sale of a piece of real estate. System programs 200, such as the search management program, for example, receives automatic updates when the site that stores the real estate transaction information is an automated storage site where the information is stored electronically. Such site locations (addresses) can be programmed into the search management program with an appropriate interfacing protocol and the present system can automatically request, or poll, these electronic storage sites for real estate transaction information on a regular basis. The search management program can also receive information that is manually entered by a researcher 120. In operation, researcher 120 collects research data e.g. bulk data transmissions to Payoff Lenders or goes to storage sites, such as county court houses, that are not automated and conducts hand searches of real estate transaction information. Armed with specific transactions to research, researcher 120 checks to see if relevant deeds have been released by Payoff Lenders, for example. If so, the researcher notes relevant data concerning the status of the release and at some later time accesses the research management program via the Internet 205 and enters the information in the appropriate record. Whether information is provided by a computer or by a person, access to the programs 200 of the present system is preferably made over the Internet 205.

The present system can receive electronic updates, from computer 215 for example, and manual updates, from researcher 120. A key piece of information that is tracked by server 100 is the date on which the underlying evidence of debt or Note was paid by the Settlement Agent and accepted by the Payoff Lender. In all jurisdictions, the lender or lien creditor holding a paid off lien in a real estate transaction is given a specific amount of time after the settlement date to release the deed to the property. When the lien is released, the title of the real property is “clear” and allows the Originating Lender in the transaction to hold a priority position.

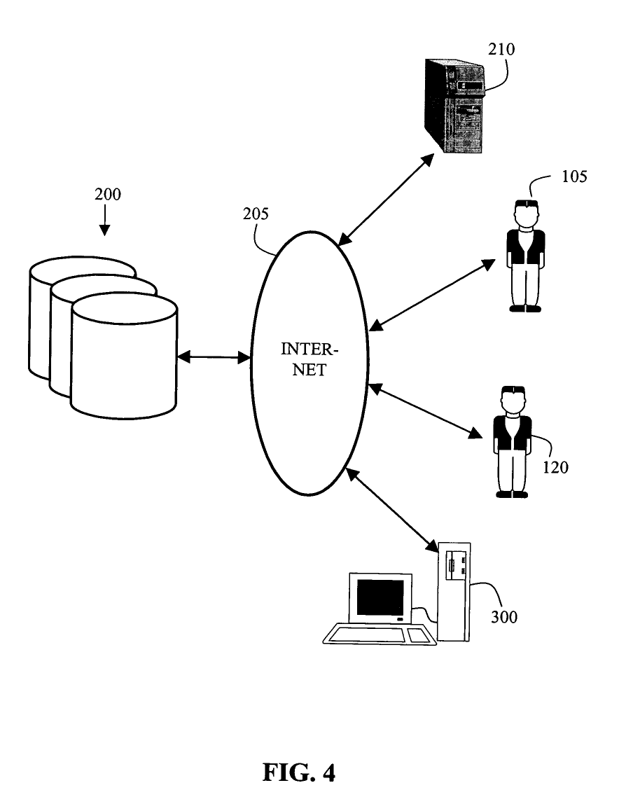

Referring to FIG. 4, when the programs 200 of the present system send information to an individual, such as agent 105 or researcher 120, or to a remote computer, such as a subscriber's computer 210 or an attorney's computer 300, the information is preferably transmitted over the Internet 205. Through use of the Internet, the present system can send real estate information and related forms to personnel at any location with Internet access. Further, by being accessible via the Internet, the programs 200 can be accessed by personnel and computers at any location with Internet access. Programs 200 include composite reporting templates composed of sequences of legal phrases and statements. The programs 200 also include statutory obligations for multiple jurisdictions regarding the handling of releases of deeds of trust and other encumbrances. When tracking records, the programs 200 preferably use the statutory time period set by the state in which the property is located to test whether or not the statutory time period has passed. Each record within the database may be assigned an unlimited number of attributes. Programs 200 further implement an information mapping system that allows flexibility in information packaging and adaptive interfacing with legacy systems.

After the record is updated with the search results, and the lien is not released within the specified time, then the a forms program will create a series of demand letters addressed to the paid off lender demanding that the lien be released. If the lien was released within the statutory period, the relevant information concerning the index location of the public record, the time of the search and the date of the recording of the release are updated. The record is then marked for archival after the release information is reported to the Settlement Agent.

### The User Interface Programs

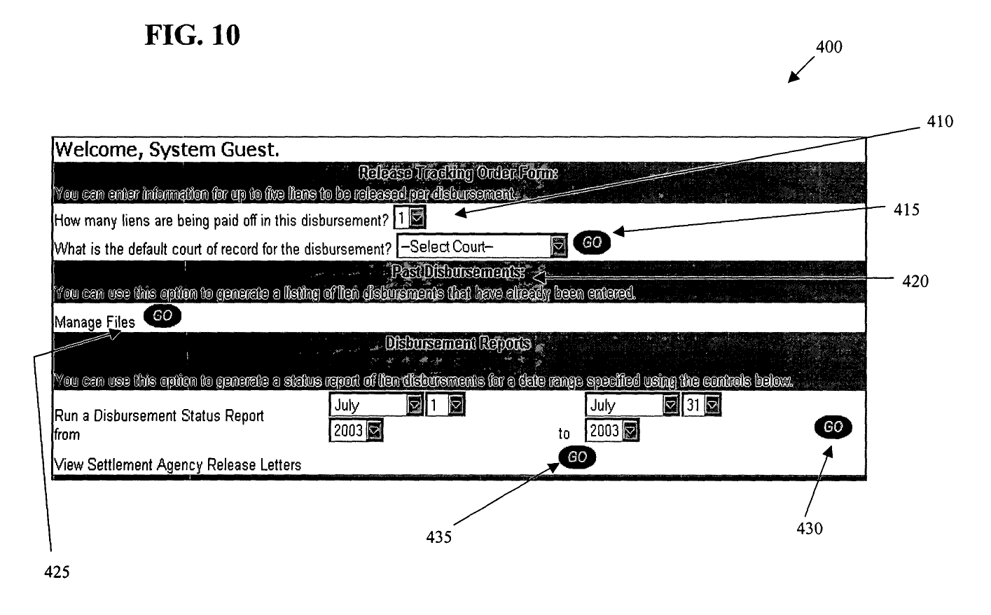

The user interface programs provide a graphical user interface for settlement agents 105. The user interface programs allow agents to manually enter current lien information and other transaction data, relating to one or more real estate transactions, into the present system. The user interface programs can also tap into existing data stored on the agent's own computer system 210 and allow data from computer system 210 to be uploaded directly to the present system. In the alternative, the user's resident programs can be configured to “push” resident data to the web-based system. As shown in FIG. 10, for example, a user interface 400 can provide a settlement agent or similar release tracking entity with a menu of options. In the sample interface of FIG. 10, the user can enter number of liens for payoff as at 410, select a default court as at 415, generate a listing of past lien disbursements as at 420, manage files as at 425, generate a status report covering a specified time period as at 430, and view settlement release letters as at 435.

Upon selection of a release tracking order form, the user can be provided with an interface 450 as shown in FIG. 11A. Interface 450 provides a sample lien information entry form having text entry areas for settlement information 455, such as disbursement date and settlement agency file number, obligor information 460, property-specific information 465 and official information 470 such as tax parcel ID and default court of record. As shown in FIG. 11B, payoff information form 475 can receive various note payoff 480 and lien record 485 information.

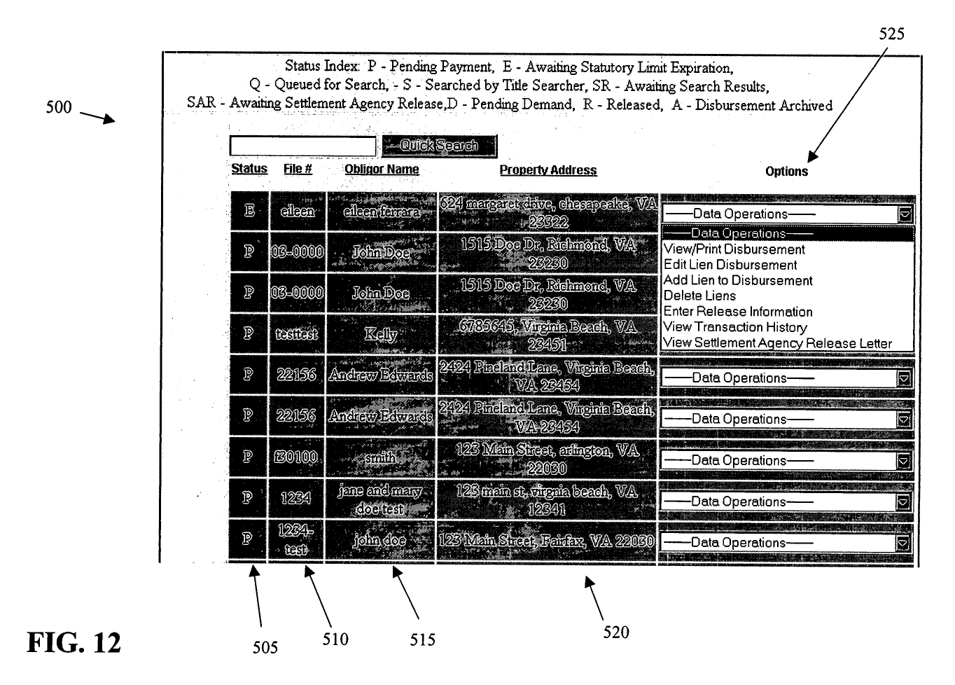

Upon selection of the option to manage files, the user can be provided with an interface 500 as shown in FIG. 12. This interface 500 provides a listing of liens, each having a status designation 505 such as P for pending payment, E for awaiting statutory limit expiration, Q for queued for search, S for searched by title searcher or online, SR for awaiting search results, SAR for awaiting settlement agency release, D for pending demand, R for released and A for disbursements archived. Identifiers such as file numbers 510, obligor name 515 and property address 520 can also be provided in the lien management interface 500. The user of this interface can further be provided with options 525 such as viewing or printing a disbursement, editing a lien disbursement, adding a lien to a disbursement, deleting a lien, entering release information, viewing transaction history, and viewing a settlement agency release letter, for example.

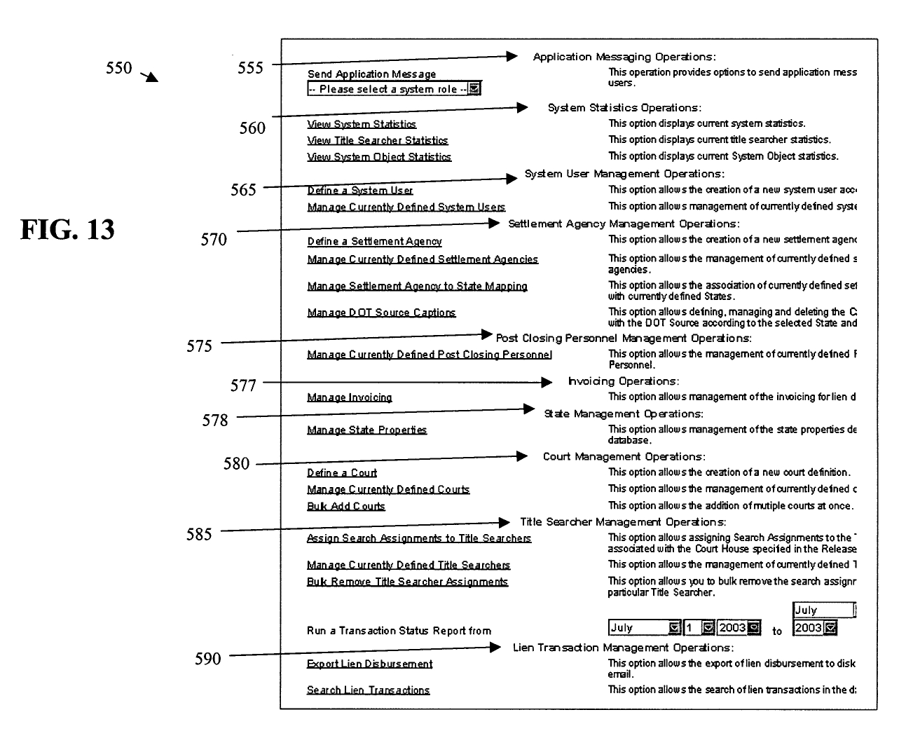

While not used in connection with ordering the tracking of a release, as shown in FIG. 13, a system administrator interface 550 can be provided with various functionalities such as application messaging operation 555, system statistic operation 560, system user management operations 565, settlement agency management operations 570, post closing personnel management operations 575, invoicing operations 577, state management operations 578, court management operations 580, title searcher management operations 585 and lien transaction management operations 590, for example. Such an interface can be used when first establishing, or later managing, the system of the present invention for use by a settlement agency, lender, title agency, legal firm or other user of the system.

### Subscriber Management Program

The subscriber management program, one of the interface programs, collects data from new subscribers, defines a profile for the subscriber, and sets parameters for other programs in the system that customize their actions. The subscriber management program insures that report generators conform to a subscriber's profile when generating documents. This program also sorts and filters subscriber's data, and provides messaging services for the subscriber and system managers (administrators).

### Order Placement And Invoicing Program

The order placement and invoicing program, another interface program, generates input interfaces that are used to collect transaction data from subscribers. Payoff orders are pushed to the Payoff Lender though the system. Payoff Lenders deliver the payoff statements to the agents though the system. The order placement and invoicing program then generates invoices to the subscribers and collects verification of payment data from various data entry interfaces. The payment data can be verified electronically, if paid by credit card for example, or with the assistance of an administrator, if payment is made through the mail. Upon verification, a transaction record is created for each real estate transaction, and the order placement and invoicing program releases the records to other programs in the present system.

### Real Estate Forms Program

The real estate forms program receives the transaction data from the order placement and invoicing program and generates one or more real estate forms that are required by the agent 105. The real estate forms are then transmitted to the agent so that the agent can print the forms locally. The one or more real estate forms that are provided to the agent can include, for example, payoff letters, invoices, demand letters, certificates of satisfaction or release instruments, fax cover sheets, overnight shipping labels, and transaction reports. The reports can be generated by vendor system and presented to the agent as part of the collection of forms. The reports can include, for example, lien information, obligor information, settlement information, pay-off information and loan information.

### Research Management Program

The search management program provides title researcher interfaces and research order and delivery programs to collect and manage research data. The program collects records ready for research, matches the record with a subscribing researcher, assigns the research to the researcher accepting the order and tracks the efficiency and accuracy of researchers. A research return interface is provided to collect the results of the research—e.g. released or not released, or release pending delivery to court. The research management program also provides interfaces and applications to conduct automatic searches on various land record repositories incorporating electronic internet-based indexes. The program determines whether the research information is available electronically or whether to assign the research order to a research subscriber. The research management program also tracks payment to researchers for their work performed.

The research management program can track researcher's response time and accuracy of searches, for example. If the researcher has not responded during a specified time the system automatically notifies the researcher through email, fax or other predetermined method that the record has been assigned to another researcher, or requests an explanation as to the delay. A research management program can be assisted by an administrator, or quality assurance personnel, that will monitor the proper and timely entry of the search results. System administrators are preferably on the same local area network as the system and thus are not shown in FIG. 3.

### Tracking Program

The tracking program also receives the transaction records from the order placement and invoicing program and creates an electronic lien record for each entity holding a lien, or other encumbrance, on the real estate that is the subject of the transaction. The system may track multiple liens associated with the real estate transaction, such as occurs when second and third mortgages are taken out on a house for example. At various times the tracking program receives update information, from the research management program, for each lien record and uses the update information to update information in specified fields of the lien records. Upon the occurrence of one or more specified events, the tracking program sends out one or more notifications.

The tracking program tracks the statutory time period for each jurisdiction where the property is situated. If a Settlement Agent enters information that they received a fully executed lien release instrument and intends to record the instrument, or if they receive a copy of a recorded lien release instrument and enter the recording information on the lien release, the record is flagged to be reported to the Settlement agent and then archived. If there is no intermediate information entered concerning the lien record between the time of payoff disbursement and the expiration of the statutory period, then upon expiration of the statutory period, the record is flagged to be included in the research queue. Those records with the status of being ripe for research are allocated by the research management program—the record is automatically assigned to researchers that are members of the system, to be researched through contact with Payoff Lenders, entry of data delivered to agent or searches at the respective court house. If the repository has an electronic data indexing system, the system automatically searches the index for a record of a release or re-conveyance or a status of release of the subject lien.

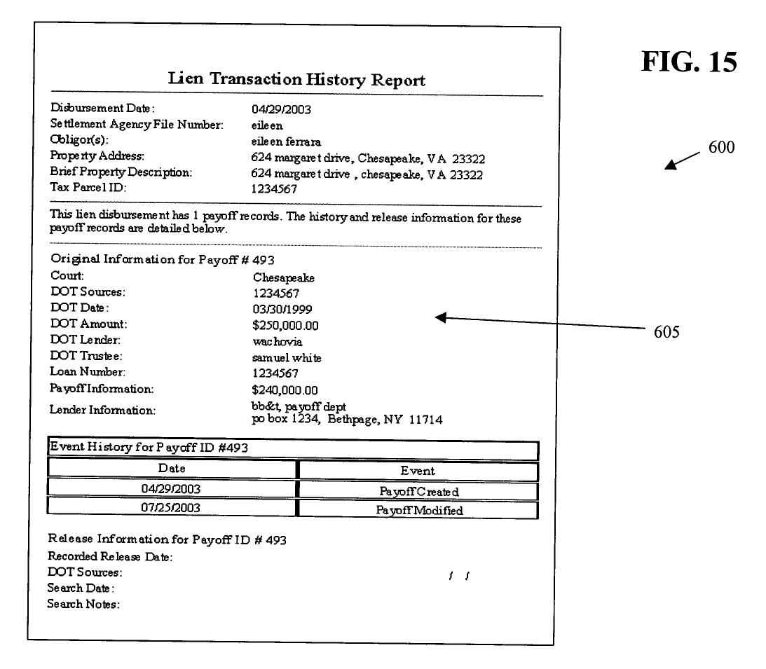

As shown in FIG. 15, a lien transaction history report 600 can provide lien disbursement information 605 associated with a particular lien.

### Legal Forms Program

The legal forms program acts on notifications received from the tracking program. The legal forms program includes legal form masks, also called templates, for multiple jurisdictions that are used generate the legal forms, including release instruments, notices and demand letters. The release instrument or demand letter can be sent to a system administrator for subsequent mailing to the delinquent Payoff Lender, or the form can be sent automatically. If the lien is not released within the time specified in the demand letter, then the legal forms program will receive another notification from the tracking program, which will initiate the production of other legal forms that can be used to initiate self-help release documents used buy the agent or, if necessary, begin a civil action against the offending lien holder. As shown in FIG. 14, a payoff disbursement package 342 sent by a settlement agent can include legal forms for use by a Lender, including such forms as a notice of intent to release and a certificate of satisfaction, for example.

The legal forms program includes legal form masks, also called templates, for multiple jurisdictions that are used generate the legal forms, including release instruments, and demand letters. All jurisdictions further impose a fine on lenders or lien creditors that do not release the lien, within a specified amount of time, after receipt of the payoff funds and notice of full payment or demand. The tracking program continues to track the record after a demand letter is sent. If the deed is not released within the specified amount of time, then the legal forms program is notified and prepares the proper legal forms required to take action against the delinquent lender. The system then transmits the legal forms to a system administrator for subsequent transmission to a law firm in the seller's jurisdiction, for filing in the appropriate court of law. Of course, with pre-arrangement, the system can also send the legal forms directly to a law firm.

The legal forms program generates legal documents that can be filed by a competent attorney with a court in the applicable jurisdiction. The legal forms indicate that the lien holder has violated a state law and provide all the information required by the relevant jurisdiction. The legal forms can be sent to an administrator or the legal forms can be sent directly to a law firm or private attorney in the appropriate jurisdiction, i.e., the jurisdiction in which the property is located.

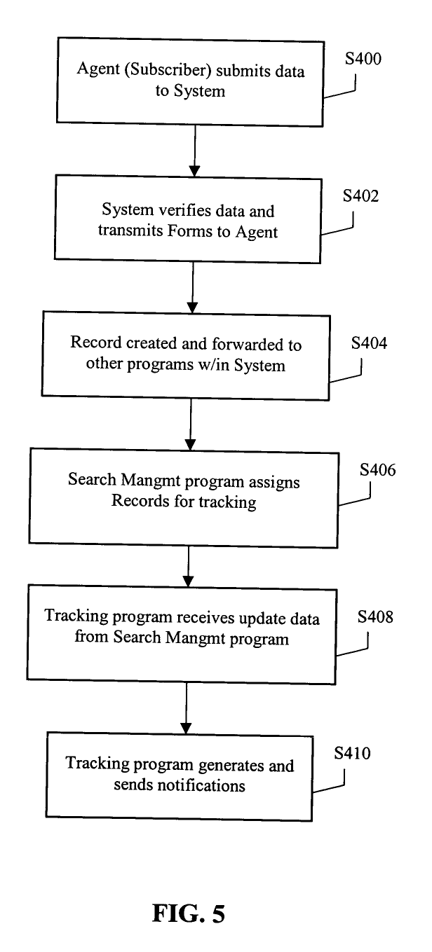

FIG. 5 shows the general operation of one embodiment of the present system. In step S400 an agent subscribes to the present tracking system by providing some financial data to the present system, thus the agent may also be referred to as a subscriber. Also in step S400 the agent enters transaction data into the system that is used to create a subscriber's profile for the agent. In step S402, the system verifies the financial data and upon verification, the system uses the subscriber's profile to generate and transmit forms and documents for use by the agent. The forms and documents are customized for the agent and transmitted so that the agent can print the forms locally. The forms and documents relate to the transaction that was entered in the system and are customized to the jurisdiction in which the agent works. The present system can also provide unofficial documents to the agent such as fax cover letters and shipping labels. In step S404, a transaction record is created that includes the transaction data entered by the agent. Each transaction record includes at least one lien record representing an entity that is to be paid off upon the close of the transaction. If there is more than one entity to be paid off then there will be more than one lien record that is tracked. The system then, in step S404, forwards the transaction record containing the transaction data to other programs in the system. In step S406, the search management program receives the record and assigns the record for tracking. If the record can be tracked electronically, the search management program initiates electronic tracking and forwards the record to the tracking program. If the record must be tracked by manual searching, then the record is assigned to a researcher and the record is forwarded to the tracking program. In step 408, the tracking program receives update data from the search management program and uses the update data in tests to determine if notifications should be generated. Update data is provided either from a researcher or from another computer. The present system keeps track of many pieces of information however one of the more important pieces of information is whether or not the encumbrance, deed of trust for example, has been released after the settlement date of the real estate transaction (transaction record). In step S410, the tracking program tests to see if the encumbrance has been released for a specific record. If the encumbrance was released within the statutory period after the settlement date, then the lien holder has done what they were obligated to do and tracking of that record can end. If, however, the encumbrance was not been released within the statutory time period then the tracking program generates and sends notifications to other programs and/or to an administrator. The statutory time period, typically thirty days, is set by the state and begins to run on the settlement date of the transaction.

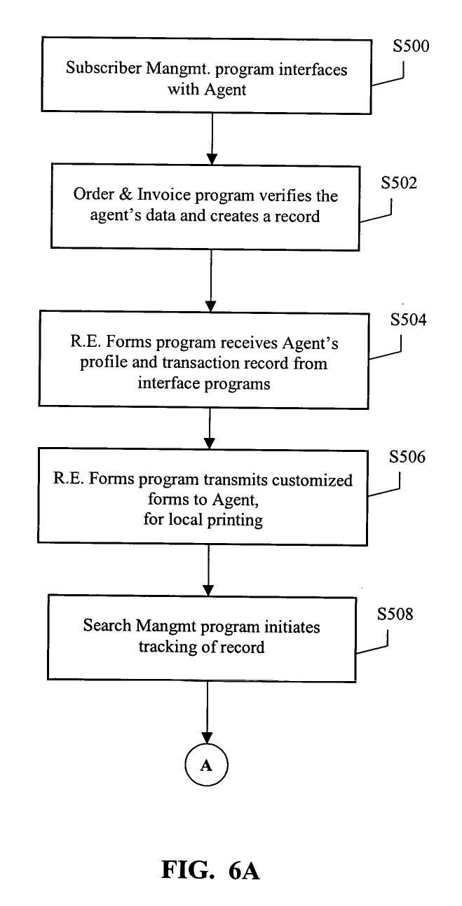

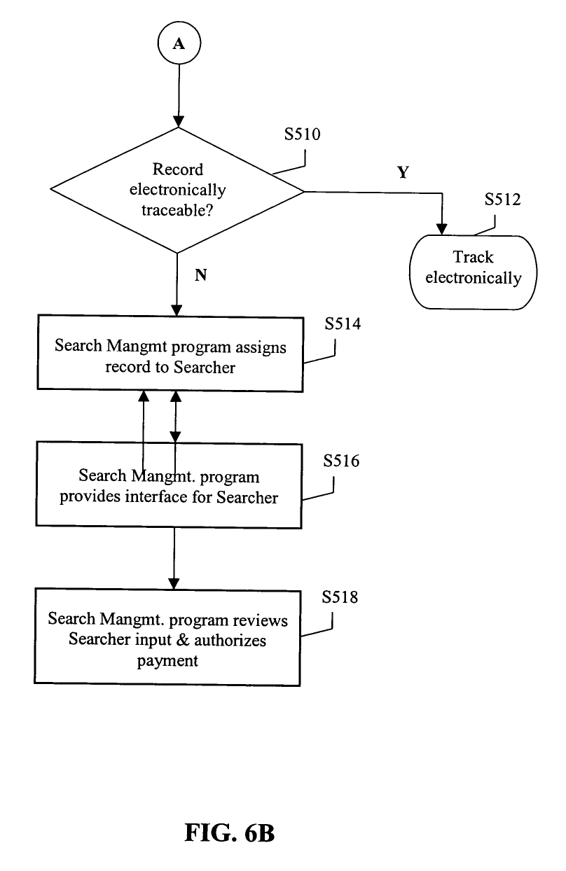

FIGS. 6A and 6B provide more detailed steps of the preferred method. Referring to FIG. 6A, in step S500, the agent accesses the present system, preferably via the Internet, and interacts with the subscriber management program, which prompts the agent for required and optional data. Based on information provided by the agent, the subscriber management program creates a subscriber profile for the agent. The subscriber profile is used by other programs in the system to, among other things, determine whether or not electronic tracking is available, and which forms and documents will be generated for the agent. In step S502, the order and invoicing program receives the agent's data and verifies the financial portion of the data. Upon verification, the order and invoicing program creates a transaction record for the entered real estate transaction and sends a signal to the real estate forms program. Each transaction record is assigned a unique identifier and preferably includes information describing the seller, buyer, lender, the real estate to be sold (or refinanced), and the settlement date. After a record has been successfully created within the system the agent is rewarded with multiple forms that the agent will require to proceed with the transaction. In step S504, the real estate forms program receives the subscriber's profile and the transaction record from the interface programs. In step 506, the real estate forms program generates customized forms and documents for the agent, based on the agent's subscriber profile and the transaction record, and transmits the forms and documents to the agent for local printing. Templates for the forms and documents are stored within the present system and information from the profile and the record are added in appropriate places automatically by the system. By taking advantage of the automatic forms preparation provided by the present system, the agent gains a substantial savings in time and avoids the risk of making clerical errors. In step 508, the search management program receives the subscriber profile and the transaction record and initiates tracking of the record. Further steps of the search management program are shown FIG. 6B.

Referring to FIG. 6B, in step S510, the search management program determines whether or not the record can be tracked electronically. If the record can be tracked electronically appropriate details, such as protocol and IP address of the storage site, are noted by the search management program and transaction record is flagged for electronic tracking, step S512. The record is then forwarded to the tracking program. If the record cannot be tracked electronically the record is assigned to a researcher, step S514. The list of available researchers is stored in the present system and the search management program assigns researchers to records based on the jurisdictions in which the researcher operates, the current work load of the researcher, and the quality of previous work done by the researcher. In step S516, the search management provides an interface for researchers to submit search results produced during their manual searches. In step S518, the search management program reviews input from the researcher for accuracy and upon approval authorizes payment of the researcher.

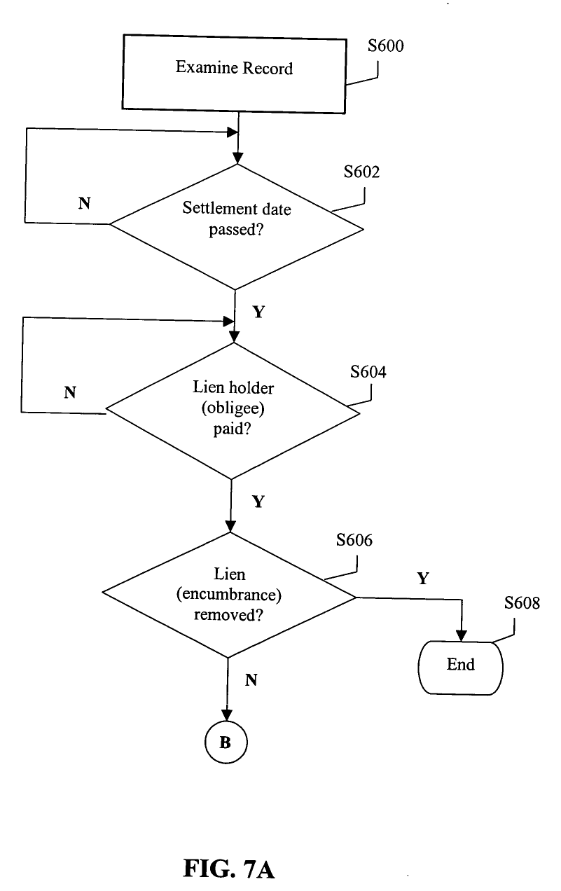

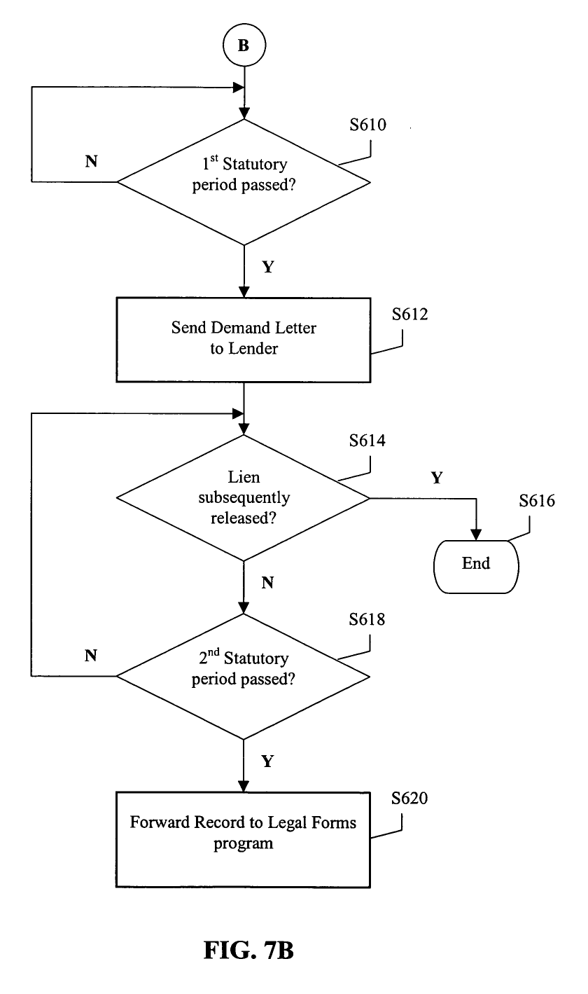

FIGS. 7A and 7B show exemplary steps of the tracking program. In step S600, the tracking program periodically, preferably at least daily, exams all transaction records. In step S602, the tracking program compares the settlement date in the record to current date to determine if the settlement date has passed. If the settlement date has not passed then no further action is taken on the record. If however, the settlement date has passed then the tracking program continues to step S604 where the tracking program checks to see the lien holder has been paid off. If there is more than one lien holder in the transaction record, each lien holder is checked by the tracking program. The tracking program uses update data from the search management program when performing tests on the records. The search management program receives the update information automatically (without user intervention) from other computers or via manual input from researchers. Continuing in step 604, if the lien holder has not been paid off then no action is taken, unless a predetermined time period has passed since the settlement date. This could indicate a problem, either with the lien holder receiving payment or with the quality of search data, and the tracking program will send a notification to the administrator prompting the administrator to investigate the problem. If any of the lien holders has been paid, then the tracking program moves to step S606 and checks to see if that lien (encumbrance) has been removed from the real property. If the lien has been removed then the tracking of that lien holder ends, step S608. If, however, the lien has not been removed then the tracking program moves to step S610 in FIG. 7B.

Referring to FIG. 7B, in step S610, the tracking program checks to see if the first statutory period has passed. In this example, it is assumed that the relevant state has two statutory periods pertaining to the release of liens on real estate after the lien holder has been paid. The first statute defines a time period, after the settlement date, within which the lien holder must release the lien. After the expiration of the first time period, a demand letter must be sent to the lien holder demanding release of the lien. The second statute defines a time period, after the demand letter has been sent, upon the expiration of which the lien holder can be forced to pay a fine for failing to release the lien. Of course, the present system can be adapted to conform to different statutes in different states.

Continuing in FIG. 7B, if it is determined that lien holder has not released the lien after the first statutory time period, then the tracking program proceeds to step S612. In step S612, the tracking program sends a signal to a forms program, which causes a demand letter to be generated and sent to the lien holder. The demand letter includes pertinent information describing the real estate transaction and demands that the lien holder file the appropriate paperwork to cause the lien on the real estate to be removed. In step S614, the tracking program checks to see if the lien has subsequently been released. If the lien has been removed from the real estate then tracking of that lien holder ends, at step S616. If however, the system finds that the lien holder has still not released the lien then the tracking program moves to step S618. In step S618, the tracking program checks to see if the second statutory time period has passed. If the second statutory time period has not passed, the program loops back to step S614. If, however, the second statutory time period has passed then the tracking program notifies, and forwards the transaction record to, the legal forms program, step S620.

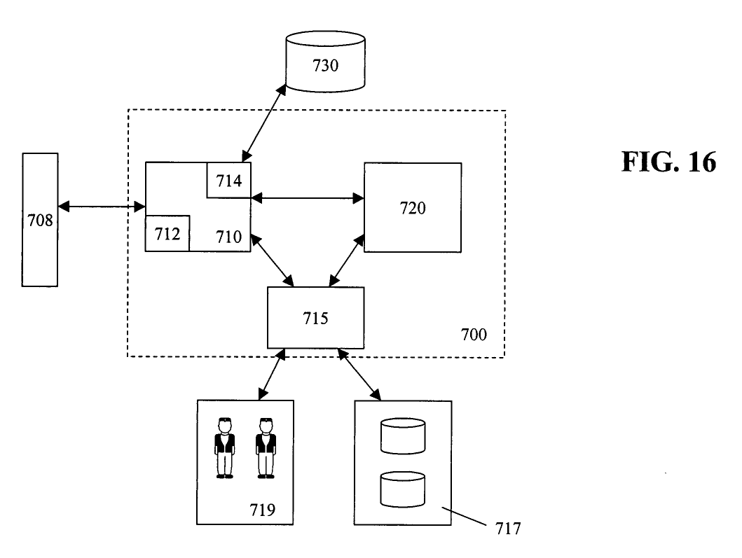

In combining various aspects of the programs outlined above, in one aspect of the present invention as shown in FIG. 16, a system, device and method for managing lien releases is provided whereby a database 705 of trigger documents are established, and access to lien records is provided to settlement agents, title searchers, title insurance agents, lenders and other administrators of liens. Trigger documents can vary in format, including such formats as electronic mail, electronic document, and hard copy document, for example. Trigger documents can also vary in substance, and can include release date notices, demand letters, payoff orders, notices of intent to release and any other documents useful to users of the present invention. In this aspect, property-related liens can be identified and trigger dates can be calculated for notifying others, generating documents to notify others or otherwise facilitating appropriate and timely workflow processing. Such identification, calculation and information processing can be part of a lien management component 710 of the present invention. The system allows access to lien record searching component 715 capable of searching lien record information from a plurality of lien record-keeping jurisdictions, both electronically 717 and manually 719. With such information, the system can determine whether a lien has been satisfied and whether a lien has been released as part of a lien status identification component 720, also shown in FIG. 16. A lien will be considered satisfied if the note underlying the lien has been paid, for example. A lien will be considered as released if the payoff lender has generated and submitted appropriate release documentation to the jurisdiction responsible for keeping the lien records associated with the given lien. In one embodiment, access to lien records of multiple jurisdictions is available in real-time, i.e., as desired, and queries of multiple jurisdictions can be run substantially simultaneously.

The lien management component 710 and lien status identification component 720 incorporate aspects of the user interface, research management and tracking programs identified above. In one embodiment, the lien management component 710, lien status identification component 720 and lien searching component 715 embody a system server 700 of the present invention.

In this aspect, the lien can be identified by lien holder, obligor identity, loan amount, payee identifier and/or lien jurisdiction, for example. The database of trigger documents can include those described earlier, such as demand letters intended for lien holders and legal forms adapted to the jurisdiction associated with a given lien, as described earlier. The trigger date calculation can be jurisdiction-specific. For example, some jurisdictions may calculate deadlines for payoff lender releases of liens based on the date of settlement, others based on payoff date, and so forth. In another embodiment, the trigger date can be calculated based on an overdue release date. Statutory requirements can be stored in a database accessible to the settlement agent and other entities identified above via network connection, for example, and such statutory requirements can be updated on an individual jurisdictional basis.

In another aspect of the present invention, a system, device and method are provided whereby the lien management component 710 provides access via the lien searching component 715 to lien records (either electronically or manually) for a plurality of lien record-keeping jurisdictions. The lien status identification component 720 can determine whether any particular lien for which lien information is available is due for release and whether a lien holder is due for notice or is subject to a system action for non-release of a lien, for example. Such an action might be a notice of delinquent release, or notice of lawsuit, for example. In one embodiment, the lien searching component provides real-time access to a plurality of jurisdictions at substantially the same time. In this way, reports can be run quickly for a settlement agent, who may be dealing with several lien holders and multiple jurisdictions, or for a payoff lender, who may be dealing with loans crossing several jurisdictions.

The lien status component 720 can act to periodically re-evaluate results of determinations, automatically as pre-established by a user, on an ad hoc basis, or as changes are noted in identified liens or lien holders by the system of the present invention. Such re-evaluation is shown, for example, in FIGS. 7A and 7B. Time intervals can be daily, weekly or otherwise, for example. Upon re-evaluation, the present invention may discover additional liens due for release, or lien holders due for notices or other action. A reporting component 712 in connection with the lien management component can present a report showing all liens due for release and/or any lien holders subject to action for non-release of a lien.

In one embodiment of this aspect of the present invention, the main server can include programming as part of its lien release tracking to identify and report on released liens. The present invention can further include programming to access a courthouse or other jurisdictional entity's database of jurisdictional-specific rules regarding lien releases. Such programming can be part of the lien status component, or can be a user interface 708 to allow active querying of such a database. A document generation component 714 can also be included as part of this aspect of the present invention within the lien management component to assist users in generating appropriate documents based on a given lien's status.

In a further aspect of the present invention, as shown in FIG. 17, a system, device and method are provided whereby a central, network-accessible server 700 is provided with access to lien record information for a plurality of lien record-keeping jurisdictions, as well as access to a database of electronic documents related to lien management and release tracking. The server can be provided with programming to identify lien statuses based on the jurisdiction associated with the lien and specific lien transaction information, such as when settlement occurred which would result in payoff of the note underlying the lien, as described earlier. Appropriate calculations of trigger dates can be a part of the programming provided to identify lien status. Several interfaces are further provided with access to the central server, as shown in FIG. 17. One interface 750 can allow access to the server for inputting lien identification and transaction information. Another interface 752 can allow access to the server for requesting a search of lien records. Another interface 754 can allow access to the server to display status information about a lien. Still another interface 756 can allow access to the server to request that a document be generated based on the status information discovered. Another interface can request that the system monitor a specific set of liens and report every time there is a change in the status of a release related to one of the liens in the set. This can benefit a lender, title agent or settlement agent wishing to track their lien portfolio.

It will be appreciated that a single entity or entity-type may use more than one interface in interacting with the system of the present invention, and a single computer can be capable of displaying all interfaces via menu selection, toggle selections and other well-known display manipulation techniques.

In another aspect of the invention, from the perspective of a settlement agent, title insurer, attorney or similar user, the present invention provides a system, device and method whereby a first interface can receive property-related lien transaction information including at least a critical date and a lender identification associated with at least one property loan. The interface is further capable of receiving a request for lien release tracking or monitoring. A second interface can display lien status information corresponding to the lien, wherein the status information includes information as to whether a lien of the identified lender has been either satisfied or released. A communications component can notify at least one entity in the event the trigger date is passed without receiving notice of satisfaction or release of the given lien.

The transaction information can be related to a plurality of loans for an identified lender, and the agent can request system monitoring of lien records associated with the plurality of loans for the identified lender. Additionally, the transaction information can be related to a plurality of loans within a given jurisdiction for a plurality of identified lenders. Further, the transaction information can be related to a plurality of loans for an identified lender within a plurality of jurisdictions. In this way, the present invention accommodates a settlement agent, for example, seeking information about a particular jurisdiction, or separately about a specific lender's loans across a single or multiple jurisdictions. Appropriate trigger documents and notices may also be accessible to the users to facilitate loan settlement management.

In a further aspect of the present invention, a system, device and method provide a lien management component for receiving and storing lien identification information. An interface allows a user to receive a notice providing status information about a particular lien and issue a response to the notice. For example, the user may request the system to monitor lien records for satisfied but not timely released liens. The present invention in this aspect can determine a basis for holding a lien as not timely released as described above in connection with calculating trigger dates on a jurisdictional basis, for example. If a lien is discovered as not having been timely released, programming in connection with this aspect of the present invention can deliver a notice (electronic or otherwise) to the agent informing of the delinquent release. In response, the user can use an interface to deliver or print a notice for delivery to the lien holder involved. It will be appreciated that the notice can be a demand letter, a payoff disbursement package, a payoff order, or a closing communication for example. The generated document can be a payoff letter outlining the current terms of the note underlying the lien at issue. The document can alternatively be a notice of receipt of a payoff package, a notice of payment shortage or confirmed correct payoff amount after payoff. The document can further be a lien release, generated in response to satisfaction of the note underlying the lien.

It will be appreciated that a plurality of network architectures, communications protocols and system hardware can be employed to implement all of the above embodiments of the present invention. For example, the present invention can employ a Microsoft Windows™ operating system with the latest version of Internet Explorer™ on the server and client devices, can employ Microsoft Word™ and/or Adobe™ PDF formatted word processing documents, and can employ TCP/IP protocol as is well-known in the art. Further, the present invention can employ a thin client architecture with heavy server-side programming or a thick client architecture whereby more processing is conducted on the user's local computer, thereby streamlining server operations.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

What is claimed and desired to be secured by Letters Patent is:

1. A method for managing lien releases, comprising the steps of:
(a) providing access to lien records for a plurality of lien record-keeping jurisdictions, each of said lien records including a respective lien holder entry;
(b) identifying at least one lien where a note underlying the at least one lien has been satisfied, and identifying whether the at least one lien in said database is due for release;
(c) identifying whether at least one lien holder is subject to an action for non-release of a lien;
(d) repeating steps (b) and (c) at given time intervals; and
(e) presenting a report of a subset of said lien records, said report including the identification of any liens due for release and any lien holders subject to penalty for non-release associated with said subset.

2. The method of claim 1 wherein step (e) is operable upon receiving a request.

3. The method of claim 1 wherein step (e) is operable upon detection of a change in said identified liens or lien holders.

4. The method of claim 1 including the step of: (f) identifying released liens.

5. The method of claim 1 including the step of: (f) providing a database of jurisdictional-specific rules regarding lien releases.

6. The method of claim 5 including the step of: (g) providing a database of documents associated with said rules.

7. The method of claim 1 wherein step (a) involves providing real-time access to said plurality of jurisdictions at substantially the same time.

8. The method of claim 1 wherein said given time intervals are established by individual request.

9. The method of claim 1 wherein steps (a) through (e) are controlled by a network-accessible server.

10. A system for managing lien releases, comprising:
a lien management component for providing access to lien records for a plurality of lien record-keeping jurisdictions, each of said lien records including a respective lien holder entry;
a lien status identification component for identifying at least one lien where a note underlying the at least one lien has been satisfied, and identifying whether the at least one lien is due for release, and for identifying whether at least one lien holder is subject to an action for non-release of a lien, said status component including means for iteratively querying said lien records and performing said identifications at given time intervals; and
a reporting component for presenting a report of a subset of said lien records, said report including the identification of any liens due for release and any lien holders subject to penalty for non-release associated with said subset.

11. The system of claim 10 wherein said reporting component is operable upon receiving a request.

12. The system of claim 10 wherein said reporting component is operable upon detection of a change in said identified liens or lien holders.

13. The system of claim 10 wherein said lien status component includes means for identifying released liens.

14. The system of claim 10 wherein said lien status component includes means for providing access to a database of jurisdictional-specific rules regarding lien releases.

15. The system of claim 14 further including a document generation component for generating documents associated with said rules.

16. The system of claim 10 wherein said lien record-tracking component provides real-time access to said plurality of jurisdictions at substantially the same time.

17. The system of claim 10 wherein said given time intervals are established by individual request.

18. The system of claim 10 wherein said components are controlled by a network-accessible server.

19. A method for managing lien releases, comprising the steps of:
receiving transactional information related to at least one lien;
providing at least one electronic document based on said transactional information;
determining whether a lien record associated with said at least one lien can be tracked electronically and whether the at least one lien is due for release as a result of a note underlying the at least one lien having been satisfied;
searching for said lien record;
receiving search results associated with said lien record; and
presenting a report identifying a release status associated with said lien record.

20. The method of claim 19 wherein said searching step includes initiating communications to determine whether said lien has been released to at least one of: a payoff lender, a settlement agent, a courthouse, a third party title insurance underwriter.

21. A system for managing lien releases, comprising:
a lien management component for receiving transactional information related to at least one lien and providing at least one electronic document based on said transactional information;
a lien searching component for determining whether a lien record associated with said at least one lien can be tracked electronically and whether the at least one lien is due for release as a result of a note underlying the at least one lien having been satisfied, searching for said lien record, and receiving search results associated with said lien record; and
a reporting component for presenting a report identifying a release status associated with said lien record.

22. The system of claim 21 further including a communications component for initiating communications to determine whether said at least one lien has been released to at least one of: a payoff lender, a settlement agent, a courthouse, a third party title insurance underwriter.

23. A method for brokering lien release information, comprising the steps of:
providing a network-accessible server having access to lien record information for a plurality of lien record-keeping jurisdictions, said server further having access to a database of electronic documents associated with at least one lien status, and further having means for identifying a lien status based on transaction information and jurisdiction information associated with a lien;
providing at least one user interface capable of accessing said server for inputting identification and transaction information pertaining to at least one lien;
providing at least one user interface capable of accessing said server for requesting at least one search in connection with at least one lien and for requesting a determination as to whether the at least one lien has been released where a note underlying the at least one lien has been satisfied;
providing at least one user interface capable of accessing said server for displaying status information related to at least one lien; and
providing at least one user interface capable of accessing said server for requesting the generation of at least one document in connection with at least one lien.

24. The method of claim 23 including the further step of providing at least one user interface capable of accessing said server for requesting notification of a change in status information pertaining to at least one lien.

25. The method of claim 23 wherein said lien record information includes at least one of title information, recording information, indexing information, and financial information.

26. The method of claim 23 wherein said lien transaction information includes at least one of a date of settlement, a date of disbursement and a date of notice of payoff payment to a lender.

27. The method of claim 23 wherein said lien jurisdiction information includes a statutory time limit for releasing liens upon satisfaction.

28. The method of claim 23 wherein said lien identification information includes at least one of an obligor, a lien holder, a loan amount, a payee identifier and a lien jurisdiction.

29. The method of claim 23 wherein said lien status information includes at least one of pending payment, awaiting statutory limit expiration, queued for search, searched by title searcher, awaiting search results, awaiting settlement agency release, pending demand, released and disbursement archived.

30. A system for brokering lien release information, comprising:
a network-accessible server having access to lien record information for a plurality of lien record-keeping jurisdictions, said server further having access to a database of electronic documents associated with at least one lien status, and further having means for identifying a lien status based on lien transaction information and lien jurisdiction information;
at least one user interface capable of accessing said server for inputting identification and transaction information pertaining to at least one lien;
at least one user interface capable of accessing said server for requesting at least one search in connection with at least one lien and for requesting a determination as to whether the at least one lien has been released where a note underlying the at least one lien has been satisfied;
at least one user interface capable of accessing said server for displaying status information related to at least one lien; and
at least one user interface capable of accessing said server for requesting the generation of at least one document in connection with at least one lien.

31. The system of claim 30 further including at least one user interface capable of accessing said server for requesting notification of a change in status information pertaining to at least one lien.
